(19) United States
(12) Patent Application Publication
(10) Pub. No.: US 2018/0015670 A1
(43) Pub. Date: Jan. 18, 2018

(54) PROCESS FOR FORMING POLYMERIC PARTS UNDER VACUUM CONDITIONS

(71) Applicant: SABIC GLOBAL TECHNOLOGIES B.V., Bergen op Zoom (NL)

(72) Inventors: Hao Gu, Bergen op Zoom (NL); Thomas Hocker, Pittsfield, MA (US); Scott Davis, Pittsfield, MA (US); Lanti Yang, Bergen op Zoom (NL)

(21) Appl. No.: 15/547,826

(22) PCT Filed: Feb. 23, 2016
(86) PCT No.: PCT/IB2016/050986

§ 371 Date: Aug. 1, 2017

Related U.S. Application Data
(60) Provisional application No. 62/119,328, filed on Feb. 23, 2015.

(51) Int. Cl. B29C 41/06; B29C 41/50; B29K 69/00

(52) U.S. Cl. CPC B29C 64/255; B29C 41/06; B29C 41/50; B33Y 10/00; B29C 64/153; B29K 2069/00

(57) ABSTRACT

A system for fabricating a part (12) comprises a build chamber (14), a powder feed system (18) for feeding a polymeric powder (22) to the build chamber, a heating system (40) for melting and fusing the polymeric powder to form a fused polymeric part in the build chamber, and a vacuum system (50) to apply a specified vacuum pressure to the build chamber, wherein the vacuum pressure is at or below a threshold pressure so that a porosity of the fused polymeric part is at or below a specified threshold porosity.

### BACKGROUND

On-demand fabrication of parts using three-dimensional (3D) computer-assisted design (CAD) data, also referred to as 3D printing, has been improving and becoming more prevalent. 3D printing technologies can include several different technology methods. An example of a 3D printing method is selective laser sintering, which uses a focused laser beam to heat and fuse a powder material to fabricate parts. Another example for forming 3D parts is rotational molding, also known as rotomolding, which places a powder material in a hollow mold and then rotates the mold while heating so that the powder material becomes molten and coats one or more inner surfaces of the mold to form a hollow part.

### SUMMARY

The present disclosure describes a system and method for forming parts out of polymeric materials, and in particular for forming parts out of amorphous polymeric materials including polycarbonate, such as via selective laser sintering or rotomolding of amorphous polymeric powder.

The present inventors have recognized, among other things, that a problem to be solved is that formation of parts from polymeric powder (especially amorphous polymeric powder, such as polycarbonate powder), for example via selective laser sintering or rotomolding, can result in a high percentage of void spaces in the resulting part because of trapped air, moisture, or volatiles in the part. Various embodiments of the system and method described herein can provide a solution to this problem, such as by applying a vacuum during heating and consolidation, which can result in rapid release of one or more of air, moisture, and volatiles from the polymeric powder, resulting in a reduction in porosity and an increase in overall part density.

The present inventors have recognized, among other things, that a problem to be solved is that formation of parts from polymeric powder (especially amorphous polymeric powder, such as polycarbonate powder), for example via selective laser sintering or rotomolding, typically results in degradation during heating and consolidation. Various embodiments of the system and method described herein can provide a solution to this problem, such as by applying a vacuum during heating and consolidation, which can result in a reduction in the energy needed for consolidation, reducing thermal degradation.

### BRIEF DESCRIPTION OF THE FIGURES

FIG. 1 is a schematic diagram of an example system for fabricating a part using selective laser sintering of a polymeric (e.g., polycarbonate) powder.

FIG. 2 is a graph of the relationship between the percent porosity of a polycarbonate part formed by selective laser sintering and its flexural strength.

FIG. 3 is a flow diagram of an example method of forming a part via selective laser sintering of a polycarbonate powder in a vacuum environment.

FIG. 4A is s schematic diagram of an example system for fabricating a part by rotomolding a polycarbonate powder before rotomolding has begun.

FIG. 4B is a schematic diagram of the example system of FIG. 4A after a polycarbonate part has been formed.

FIG. 5 is a flow diagram of an example method of forming a part via rotomolding of a polycarbonate powder in a vacuum environment.

FIG. 6A is a conceptual close-up view of particles of polycarbonate powder before heating and consolidating the powder.

FIG. 6B is a conceptual close-up view of the polycarbonate powder upon initiation of application of a vacuum.

FIG. 6C is a conceptual close-up view of the polycarbonate powder particles after heating resulting in softening or melting and fusing of the powder particles.

FIG. 6D is a conceptual close-up view of the softened or melted and fused polycarbonate powder after removal of air from the void spaces around the softened or melted and fused powder particles resulting in collapse of the void spaces.

FIG. 7 is a graph showing the size distribution of the polycarbonate powder used in the Example.

FIGS. 8A-8D show a sequence of polycarbonate powder at various times during polycarbonate powder heating and consolidation without the application of vacuum during the heating cycle.

FIG. 9 shows a side-by-side comparison of two plates of polycarbonate formed by heating and consolidation, with one plate being formed without vacuum assistance (left) and one being formed with vacuum assistance (right).

FIG. 10 shows close-up photographs of an impact-tested sample of a polycarbonate slab formed without vacuum assistance.

FIG. 11 shows a close-up photograph of an impact-tested sample of a polycarbonate slab formed with vacuum assistance.

FIG. 12 shows a photograph of a 10× magnification of the polycarbonate sample shown formed without vacuum assistance (FIG. 10A), showing the formation of relatively large air voids in the slab.

FIG. 13 shows a photograph of a 10× magnification of the polycarbonate sample formed with vacuum assistance (FIG. 10B), showing the absence of large voids.

### DETAILED DESCRIPTION

Rapid prototyping of 3D parts, such as by 3D printing or other rapid prototyping methods, have been gaining popularity due to their versatility and high speed of construction. The present disclosure describes selective laser sintering (or “SLS”) of a polycarbonate powder by selectively aiming of a laser beam or other focused energy beam at a layer of polycarbonate powder located within a target area to selectively melt and fuse the polycarbonate to form one or more polycarbonate layers of a fused polycarbonate part. The present disclosure also describes rotational molding, also referred to as “rotomolding,” of polycarbonate powder by heating the polycarbonate powder in a mold while rotating the mold to form a polycarbonate part along at least one interior surface of the mold.

For amorphous polymeric materials, such as polycarbonate, SLS and rotomolding have been impractical because amorphous polycarbonate does not have a well-defined melting point, as with crystalline polymers, such as polyamides or polyolefins. As used herein, the term “amorphous polymeric materials,” also referred to as “non-crystalline polymeric materials” or “amorphous polymeric materials,” can refer to polymer materials that do not solidify with a long-range order typically characteristic of a crystalline polymer. Amorphous polymeric materials often have a glass transition temperature or glass transition range rather than a well-defined melting point, as is typical with crystalline polymers. Therefore, amorphous polymers tend to soften or melt over a wide temperature range rather than liquefy at a set melting point. Amorphous polymeric materials tend to have high viscosities when partially melted within the wide temperature range such that amorphous polymer powder particles will tend to more generally maintain their shape and structure and become fused together. This can result in the fused amorphous polymer powder leaving behind a relatively high porosity percentage. In addition, because amorphous polymeric material typically melts incompletely, air and other gases can become trapped in the void spaces of the resulting part. The relatively large porosity and trapped air or gas in the void spaces can lead to the resulting parts having relatively low densities and relatively low part strength. Increasing heat energy input (e.g., laser energy or oven heat) to fully melt the polymer to a low enough viscosity so that the porosity can be sufficiently reduced increases the energy requirements of the process. Moreover, increasing heat input in order to attempt to fully melt the amorphous polymer can result in polymer degradation. Examples of amorphous polymeric materials include, but are not limited to, polycarbonate and other thermoplastic polymers, such poly(p-phenylene oxide), and polyimides, such as polyetherimide.

The present disclosure describes systems and methods that are especially useful for rapid prototyping of amorphous polymers, such as polycarbonate, via heat-based formation, such as through selective laser sintering or rotomolding of powders comprising polycarbonate. The systems and methods described herein also can be used for SLS or rotomolding of materials that are more traditionally processed by these methods, such as metals and crystalline polymers. The systems and methods described herein involve applying a vacuum to the build chamber in which the polycarbonate powder is placed in order to reduce or eliminate the formation of void spaces within the polycarbonate part being formed. The vacuum applied to the build chamber can be sufficiently strong so that it evacuates air or other gasses out of the void spaces that would be formed around the softened or melted powder particles so that the would-be void spaces at least partially or totally collapse. The reduced porosity in the formed part results in increased density and strength of the part, and can also result in higher material clarity, ductility, or other improved properties. In addition, the use of the vacuum can allow for lower heat input, e.g., lower laser intensity or a reduced oven temperature, that is needed to achieve the same level of porosity, thus requiring less energy for the same process. Lower heat input can also reduce the likelihood of polymer degradation during SLS or rotomolding, for example due to charring or other thermal breakdown of the polycarbonate. Increased flow of the polymer under the vacuum pressure can also lead to improved molecular diffusion during part production. It can also result in parts that are more optically clear (for transparent polymers) or that have improved surface quality compared to parts prepared by SLS or rotomolding not under a vacuum or under an insufficient vacuum.

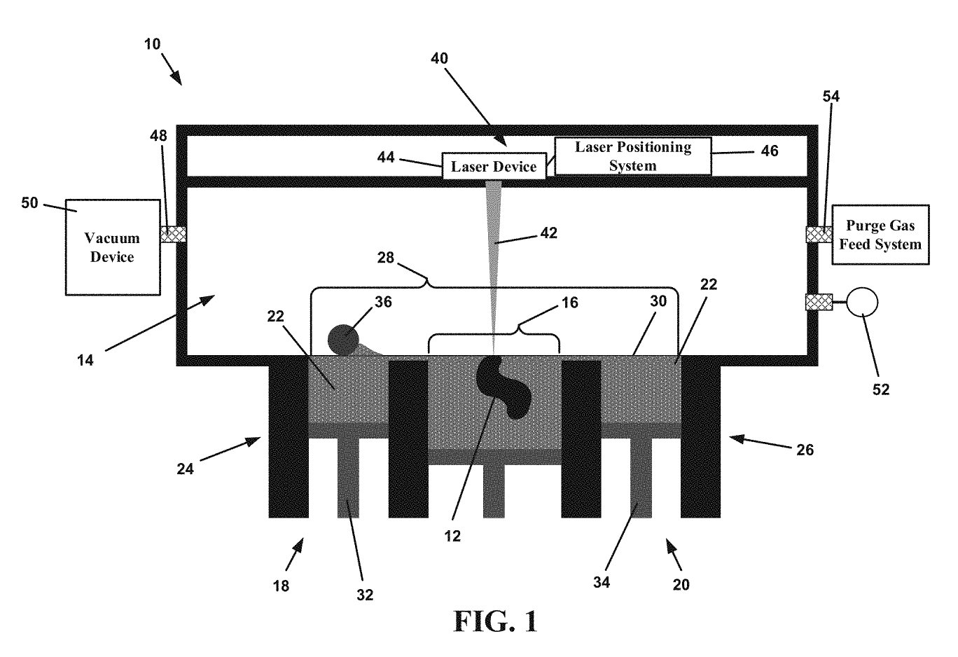

FIG. 1 shows an example of a selective laser sintering (SLS) system 10 for fabricating a part 12 from a fusible powder, and in particular for fabricating the part 12 from a fusible amorphous polymeric powder such as polycarbonate. The SLS system 10 can include a build chamber 14 enclosing a target area 16 where the part 12 is to be built.

The SLS system 10 can also include one or more powder feed systems 18, 20 to feed a fusible powder 22 to the target area 16. A first powder feed system 18 can include a first powder cartridge 24 for holding fresh powder 22 and a powder moving mechanism to move the fusible powder 22 from the first powder cartridge 24 to the target area 16. Similarly, a second powder feed system 20 can include a second powder cartridge 26 for holding fresh powder 22 and a powder moving mechanism to move the fusible powder 22 from the second powder cartridge 24 to the target area 16. The powder cartridges 24, 26 and the target area 16 can, in combination, form a powder bed 28 having an upper powder surface 30, with the target area 16 forming a portion of the powder bed 28 at the upper powder surface 30, for example a central portion of the powder bed 28.

The powder moving mechanism for each powder feed system 18, 20 can include a piston to push the fusible powder 22 upward toward the powder bed 28, such as a first piston 32 positioned in the first powder cartridge 24 for the first powder feed system 18 and a second piston 34 positioned in the second powder cartridge 26 for the second powder feed system 20. Each piston 32, 34 can push a measured amount of the fusible powder 22 upward from a corresponding powder cartridge 24, 26 to the powder bed 28. The powder moving mechanism can also include a powder pusher, such as a powder roller 36 that can push the powder 22 that has been raised up by the pistons 32, 34 from one of the cartridges 24, 26 onto the target area 16. The powder roller 36 can also level the powder 22 so that at least the target area 16 portion of the powder bed 28 has a flat or substantially flat upper powder surface 30 that is presented to the laser for sintering (described in more detail below). The powder moving mechanism can include a single powder roller 36 that can move between the plurality of powder feed systems, such as back and forth between the first and second powder feed systems 18, 20 as shown in FIG. 1, or each powder feed system 18, 20 can include its own dedicated powder roller.

The SLS system 10 also includes a system 40 that can emit a focused energy beam 42, such as a laser beam. For the sake of brevity, the system 40 will be referred to herein as a laser system 40 and the focused energy beam 42 will be referred to as a laser beam 42. In an example, the laser system 40 can be configured to emit a carbon dioxide laser beam 42, such as a CO2 laser that emits a wavelength of about 10.6 μm at a power of about 60 W.

The laser system 40 can include a laser device 44 that will emit the laser beam 42 and a laser-positioning system 46 that can position and direct the laser device 44 in order to aim the laser beam 42 within the target area 16. As noted above, the laser-positioning system 46 can be configured to aim the laser beam 42 to any position of the target area 16 within an X-Y Cartesian grid, which can allow the use of CAD data to direct the laser beam 42 while building each layer of the part 12. The laser-positioning system 46 can include a memory device that can store CAD data associated with building each layer of the part 12. The laser-positioning system 46 can also include a processor or controller that can read the CAD data from the storage device and determine the necessarily movement instructions for the laser device 44. The laser-positioning system 46 can further include one or more motors or other mechanisms that can move the laser device 44 into a desired orientation relative to the target area 16 in order to aim the laser beam 42 onto a desired location at a desired point in time in order to heat and fuse the powder 22 at predetermined locations to build each layer of the part 12.

As noted above, a conventional selective laser sintering system is not generally well suited for selecting sintering a powder 22 that comprises an amorphous polymeric material, such as polycarbonate. As noted above, polycarbonate and other amorphous polymeric materials tend to soften over a glass transition range rather than melting at a well-defined melting point and tend to have high viscosities when they do melt such that the particles of the powder 22 will tend to maintain their shape while being softened or melted such that the amorphous polymeric powder will fuse together with a large porosity percentage around the fused powder. The large porosity can result in a part that has a low density and a low strength.

The SLS system 10 of the present disclosure is configured to remove at least a portion of the void space that would otherwise occur when forming the part 12 out of an amorphous polymeric material via selective laser sintering. The SLS system 10 can prevent the formation of at least a portion of the void space that would have occurred by applying a vacuum to the build chamber 14 such that the pressure of the powder bed 28 is at or below a threshold pressure that is sufficiently low so that at least a portion of the air or other gas within the void spaces around the powder particles can be evacuated from around the powder 22, resulting in collapsing of the void spaces while the particles of the powder 22 are softened or melted from application of the laser beam 42. In an example, the threshold pressure is selected to provide for a specified void space or porosity in the part 12 that is built by the system 10. In an example, the specified porosity of the part 12 can be 15% (by volume) or less, such as 14.9% or less, 14.8% or less, 14.7% or less, 14.6% or less, 14.5% or less, 14.4% or less, 14.3% or less, 14.2% or less, 14.1% or less, 14% or less, 13.9% or less, 13.8% or less, 13.7% or less, 13.6% or less, 13.5% or less, 13.4% or less, 13.3% or less, 13.2% or less, 13.1% or less, 13% or less, 12.9% or less, 12.8% or less, 12.7% or less, 12.6% or less, 12.5% or less, 12.4% or less, 12.3% or less, 12.2% or less, 12.1% or less, 12% or less, 11.9% or less, 11.8% or less, 11.7% or less, 11.6% or less, 11.5% or less, 11.4% or less, 11.3% or less, 11.2% or less, 11.1% or less, 11% or less, 10.9% or less, 10.8% or less, 10.7% or less, 10.6% or less, 10.5% or less, 10.4% or less, 10.3% or less, 10.2% or less, 10.1% or less, 10% or less, 9% or less, 8% or less, 7% or less, 6% or less, 5% or less, 4% or less, 3% or less, 2% or less, or 1% or less.

In order to accommodate application of a vacuum to the build chamber 14, the SLS system 10 can include a vacuum outlet 48. A first end of the vacuum outlet 48 is in fluid communication with the build chamber 14 and a second end of the vacuum outlet 48 is in fluid communication with a vacuum device 50. The vacuum device 50 can be capable of drawing a sufficient vacuum pressure through the vacuum outlet 48 so that the pressure within the build chamber 14 can be sufficiently low to reduce or eliminate the void space in the part 12 if the vacuum is applied when the powder 22 has been softened or melted and fused by selective application of the laser beam 42 to the powder 22 in order to build the part 12.

Whether the pressure in the build chamber 14 is sufficiently low to reduce or eliminate the void space can depend on several factors, including the physical properties of the amorphous polymeric material such as the melt volume rate (MVR) of the amorphous polymeric material, the melt viscosity of the material, the density of the material, the molecular weight of the material, the thermal transition of the material, in terms of the glass-transition temperature (or temperature range) of the amorphous polymeric material, and the temperature to which the laser system 40 can heat the powder 22 during SLS. In an example with a polycarbonate polymeric material, the pressure in the build chamber 14 upon application of the vacuum can be at or below a threshold pressure of about −20 inches mercury (in Hg) (about −68 kilopascals (kPa)), such as at or below about −21 in Hg (about −71 kPa), at or below about −22 in Hg (about −74.5 kPa), at or below about −23 in Hg (about −78 kPa), at or below about −24 in Hg (about −81 kPa), at or below about −25 in Hg (about −85 kPa), at or below about −25.5 in Hg (−86 kPa), at or below about −26 in Hg (−88 kPa), at or below about −26.5 in Hg (about −90 kPa), at or below about −27 in Hg (about −91 kPa), at or below about −27.5 in Hg (−93 kPa), at or below about −28 in Hg (about −95 kPa), at or below about −28.5 in Hg (about −96.5 kPa), at or below about −29 in Hg (about −98 kPa), at or below about −29.5 in Hg (about −100 kPa), at or below about −30 in Hg (about −101.5 kPa), such as at or below about −35 in Hg (about −119 kPa), which can be sufficient to reduce void space within a polycarbonate part formed by SLS.

The threshold pressure within the build chamber 14 can be selected to provide for a predetermined porosity percentage of the resulting part 12 after SLS in the vacuum environment. In an example, the threshold vacuum pressure can be selected so that a predetermined absolute porosity within the resulting part 12 is achieved, such as a porosity of about 15% or less, for example about 10% or less, such as about 7% or less, about 6.5% or less, about 6% or less, about 5.5% or less, about 5% or less, about 4% or less, about 3% or less, or about 2.5% or less. In an example, the threshold vacuum pressure can be selected to provide for a percentage reduction of the porosity in the final part 12 compared to the porosity of the unsoftened and unfused powder (e.g., the powder 22 before SLS) or compared to the porosity that would have occurred if the vacuum pressure had not been applied before, during, or immediately after SLS. In another example, the threshold vacuum pressure can be selected so that the final density of the final part 12 is at or above a predetermined density, which will depend on the material or materials being used to form the part 12. In yet another example, the threshold vacuum pressure can be selected so that the density of the final part 12 is increased by a predetermined percentage compared to the density of the unsoftened and unfused powder or compared to the density that would have occurred if the vacuum pressure had not been applied before, during, or immediately after SLS.

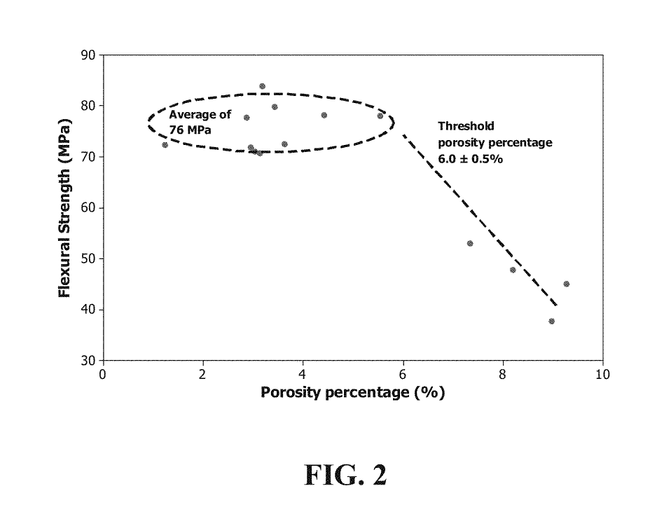

In an example, the threshold pressure within the build chamber 14 can be selected to achieve a porosity below a threshold porosity selected based on a resulting threshold value for a specified physical property, such as the flexural strength of the part. It has been found by the inventors that for amorphous polymeric materials, when the porosity of the part 12 is above a certain threshold, then the flexural strength can be reduced in a proportional manner as the porosity increases. In some examples, however, the flexural strength will tend to be about equal when the porosity of the part is below the threshold value. FIG. 2 shows the relationship between the porosity of a polycarbonate part and the flexural strength of the polycarbonate part. As can be seen in FIG. 2, there is a distinct porosity threshold at about 6%, which can be ±about 0.5% in some examples. Below this threshold 6% porosity, the flexural strength of the part 12 tends to cluster around an average of about 76 megapascals (MPa). But, above the threshold 6% porosity, the flexural strength decreases in approximately a linear fashion corresponding to the porosity percentage. It is expected that other amorphous polymeric materials will also exhibit a porosity threshold value similar to that shown for polycarbonate.

The SLS system 10 can also include a pressure sensor 52, such as a pressure gauge, that measures the pressure of the build chamber 14. The pressure sensor 52 can be used to control the vacuum device 50 in order to achieve a predetermined vacuum pressure within the build chamber 14, such as via a pressure control system. For example, the pressure sensor 52 can be in communication with a controller or processor that can be programed or otherwise configured to operate with a feedback loop between the pressure sensor 52 and the vacuum device 50. The pressure sensor 52 can also be used to control the laser system 40 so that the laser beam 42 is only activated when the build chamber 14 is under a predetermined pressure or pressure range. For example, it may be desired that the laser device 44 emit the laser beam 42 to sinter the powder 22 and build the part 12 only when the predetermined vacuum pressure is being applied to the build chamber 14, e.g., only when the pressure in the build chamber 14 is at or below a threshold pressure. Alternatively, the SLS system 10 can be configured so that the laser device 44 emits the laser beam 42 only when the pressure in the build chamber 14 is above a pressure threshold.

The SLS system 10 can also include a vent 54 in fluid communication with the build chamber 14. The vent 54 can be opened and closed for various reasons. For example, the vent 54 can be opened for the injection of a purge gas, such as nitrogen gas (N2) or argon gas (Ar), in order to purge undesirable gaseous compositions from the build chamber 14, such as organic volatiles. The vent 54 can also be opened to release the vacuum within the build chamber 14, e.g., by allowing air to flow into the build chamber 14 to equalize the pressure in the build chamber 14 with atmospheric pressure. A purge gas feed system 56 can be provided to feed the purge gas to the build chamber 14 through the vent 54.

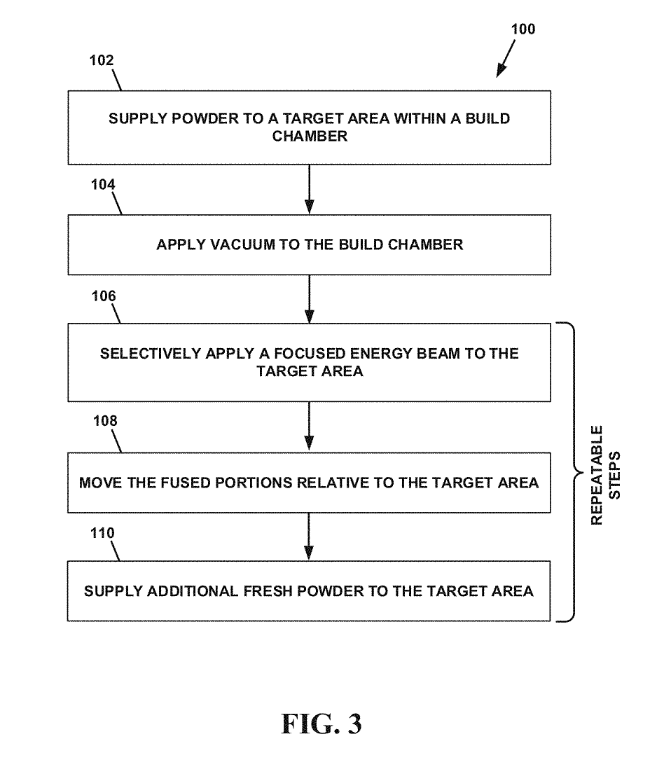

FIG. 3 is a flow diagram of an example method 100 of forming a part via selective laser sintering of a fusible powder comprising an amorphous polymeric material. The method 100 can include, at 102, supplying an amorphous polymeric polymer, such as polycarbonate powder, to a target area within a build chamber of a selective laser sintering system. At 104, a vacuum can be applied to the build chamber until the pressure within the build chamber is at or below a predetermined pressure threshold. As described above, the predetermined pressure threshold can be selected to achieve one or more of: a porosity at or below a predetermined porosity of the resulting part; at least a predetermined reduction in porosity compared to the porosity of the unsoftened and unfused powder or compared to the porosity that would have resulted if the vacuum was not applied; a density at or above a predetermined density; at least a predetermined increase in density compared to the density of the unsoftened and unfused powder or compared to the density that would have resulted if the vacuum was not applied. The application of the vacuum (104) can cause air within the build chamber to be evacuated, including at least a portion of the air within void spaces of the powder. The application of the vacuum (104) can also evacuate compounds other than air from the powder, such as volatile compounds including volatile organic compounds that may be present in the amorphous powder, such as volatile byproducts left over after manufacturing the polymeric material or formation of the powder.

At 106, a focused energy beam, such as a laser beam, can be selectively applied to the target area, such as in a patterned matter, in order to fuse the powder at selected portions of the target area. The focused energy beam can be aimed, such as using CAD data. The CAD data can include prepared CAD data corresponding to the location of material in a cross section of the final part.

After selectively applying the focused energy beam (106), at 108, the layer of the part built in step 106 is moved relative to the target area to make room for building another layer of the part. For example, the built portion of the part can be moved downward relative to the target area. Then, at 110, additional fresh powder can be supplied to the target area to provide fresh building material for a subsequent layer of the part. In some examples, the layer that has been built (e.g., after step 106) can remain molten as the part is moved relative to the target area (108) and the additional fresh building material is supplied to the target area (110).

Steps 106, 108, and 110 can be repeated as many times as needed to build the part in a layer-by-layer manner in order to complete the part. For example, a first layer can be formed by selective application of the focused energy beam (106), the first layer can be moved downward relative to the target area (108), and fresh powder can be supplied to the target area (110) so that the fresh powder is positioned on top of the first layer. Then, a second layer can be formed by selective application of the focused energy beam to the fresh powder (106), the first and second layers can be moved downward relative to the target area (108), and fresh powder can be supplied to the target area (110) and positioned on top of the second layer. Next, a third layer can be formed by selective application of the focused energy beam to the fresh powder (106), the first, second, and third layers can be moved downward relative to the target area (108), and fresh powder can be supplied to the target area (110). These steps can be repeated for a fourth layer, a fifth layer, a sixth layer, and so on until the part is fully formed.

The vacuum application (104) can be initiated and maintained while repeating steps 106 (selectively applying the focused energy beam), 108 (moving the layer(s)), and 110 (supplying fresh powder). Alternatively, the focused energy beam for each layer can be selectively applied (106) before applying the vacuum (104), so long as the selected portions of the powder are still be softened or melted when the vacuum is applied so that the air in the void spaces can be evacuated and the void spaces can collapse, as described above. In this way, the vacuum can be reapplied for each layer.

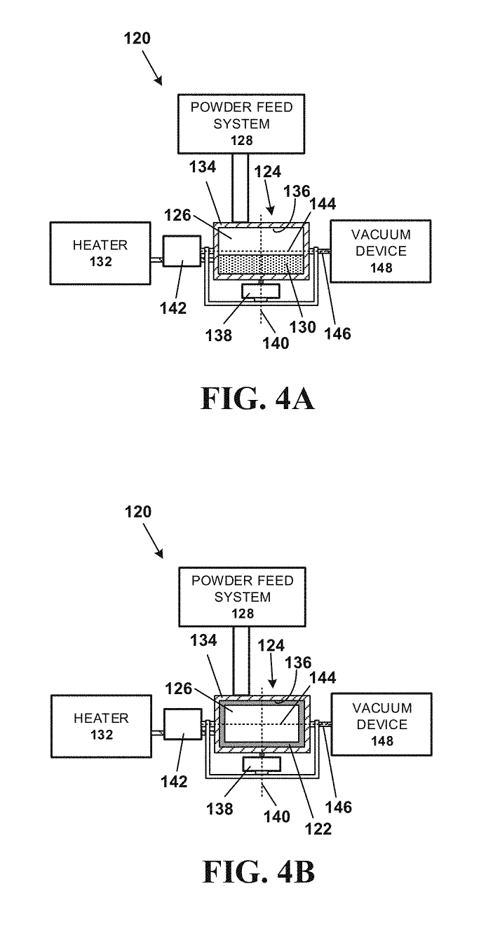

FIGS. 4A and 4B show an example of a rotomold system 120 for fabricating a part 122 (FIG. 4B) from a fusible powder, and in particular for fabricating the part 122 from a fusible amorphous polymeric powder, such as polycarbonate. The rotomold system 120 can include a mold 124 comprising a build chamber 126, also referred to as a mold cavity 126, where the part 122 is to be formed. The mold cavity 126 can have an interior shape that corresponds to an exterior shape of the part 122 to be formed.

The rotomold system 120 can include a powder feed system 128 to feed a fusible powder 130 to the mold cavity 126. The fusible powder 130 can be any amorphous or non-amorphous (e.g., crystalline) polymer that can be used to form a part 122 via rotomolding. As noted above, the rotomold system 120 can be particularly suited for forming a polycarbonate part 122, and therefore, for the sake of brevity, the fusible powder 130 will be described herein as polycarbonate powder 130.

The rotomold system 120 can also include a heater 132 for heating the mold 124 in order to heat the polycarbonate powder 130 in the mold cavity 126 in order to form molten polycarbonate. The heater 132 can directly heat the mold 124, e.g., by directly heating one or more walls 134 of the mold 124 so that heat transferred from the heater 132 to the one or more walls 134 will be transferred to the polycarbonate powder 130.

The rotomold system 120 can also include one or more rotation devices to rotate the mold 124 while the mold 124 is being heated by the heater 132, so that the molten polycarbonate formed by melting the polycarbonate powder 130 will be forced outward along one or more inner surfaces 136 of the mold walls 134. The one or more rotation devices can rotate the mold 124 monoaxially (e.g., rotation around only one axis) or biaxially (e.g., rotation about two axes that are angled with respect to each other, for example a first axis of rotation angled at 90° relative to a second axis of rotation). In an example, shown in FIG. 4, a first rotation device 138 can rotate the mold 124 around a first axis of rotation 140 and a second rotation device 142 can rotate the mold around a second axis of rotation 144 so that the rotation devices 138, 142 biaxially rotate the mold 124.

FIG. 4A shows the rotomold system 120 after the powder 130 has been fed to the mold cavity 126, but before rotomolding has been performed such that the polycarbonate remains in the form of a powder 130. FIG. 4B shows the system 120 after rotomolding, with the part 122 having been formed on at least a portion of the inner surfaces 136 of the mold walls 134.

As noted above, a conventional rotomold system is not generally well suited for rotomolding a powder 130 that comprises an amorphous polymeric material, such as polycarbonate. Polycarbonate and other amorphous polymeric materials tend to soften over a glass transition range rather than melting at a well-defined melting point and tend to have high viscosities when they do melt such that the particles of the powder 130 will tend to maintain their shape while being softened or melted such that the amorphous polymeric powder will fuse together with a large porosity percentage around the fused powder. The large porosity can result in a part 122 that has a low density and a low strength.

The rotomold system 120 described herein is configured to remove at least a portion of the void space that would otherwise occur when forming the part 122 out of the polycarbonate powder 130 via rotomolding. The rotomold system 120 can prevent the formation of at least a portion of the void space that would have occurred by applying a vacuum to the mold cavity 126 such that the pressure experienced by the powder 130 is at or below a threshold pressure that is sufficiently low so that at least a portion of the air or other gas within void spaces around the powder particles can be evacuated from around the powder 130, resulting in collapsing of the void spaces while the particles of the powder 130 are softened or melted due to application of heat from the heater 132. The threshold pressure can be selected to provide for a specified void space or porosity in the part 122 that is formed by the rotomold system 120. In an example, the specified porosity of the part 122 can be 15% (by volume) or less, such as 14.9% or less, 14.8% or less, 14.7% or less, 14.6% or less, 14.5% or less, 14.4% or less, 14.3% or less, 14.2% or less, 14.1% or less, 14% or less, 13.9% or less, 13.8% or less, 13.7% or less, 13.6% or less, 13.5% or less, 13.4% or less, 13.3% or less, 13.2% or less, 13.1% or less, 13% or less, 12.9% or less, 12.8% or less, 12.7% or less, 12.6% or less, 12.5% or less, 12.4% or less, 12.3% or less, 12.2% or less, 12.1% or less, 12% or less, 11.9% or less, 11.8% or less, 11.7% or less, 11.6% or less, 11.5% or less, 11.4% or less, 11.3% or less, 11.2% or less, 11.1% or less, 11% or less, 10.9% or less, 10.8% or less, 10.7% or less, 10.6% or less, 10.5% or less, 10.4% or less, 10.3% or less, 10.2% or less, 10.1% or less, 10% or less, 9% or less, 8% or less, 7% or less, 6% or less, 5% or less, 4% or less, 3% or less, 2% or less, or 1% or less.

In order to accommodate application of a vacuum to the mold cavity 126, the mold cavity 126 can include a vacuum outlet 146. The vacuum outlet 146 is in fluid communication with the mold cavity 126 and with a vacuum device 148. The vacuum device 148 can be capable of drawing a sufficient vacuum pressure through the vacuum outlet 146 so that the pressure within the mold cavity 126 is sufficiently low to reduce or eliminate the void space in the part 122 when the vacuum is applied to the powder 130 after the powder 130 has been softened or melted and fused while being heated by the heater 132.

Whether the pressure in the mold cavity 126 is sufficiently low to reduce or eliminate the void space can depend on several factors, including the physical properties of the amorphous polymeric material such as the melt volume rate (MVR) of the amorphous polymeric material, the melt viscosity of the material, the density of the material, the molecular weight of the material, the thermal transition of the material, in terms of the glass-transition temperature (or temperature range) of the amorphous polymeric material, and the temperature to which the heater 132 can heat the powder 130 during rotomolding. In an example with polycarbonate powder 130, the pressure in the mold cavity 126 upon application of the vacuum can be at or below a threshold pressure of about −20 inches mercury (in Hg) (about −68 kilopascals (kPa)), such as at or below about −21 in Hg (about −71 kPa), at or below about −22 in Hg (about −74.5 kPa), at or below about −23 in Hg (about −78 kPa), at or below about −24 in Hg (about −81 kPa), at or below about −25 in. Hg (about −85 kPa), at or below about −25.5 in Hg (−86 kPa), at or below about −26 in Hg (−88 kPa), at or below about −26.5 in Hg (about −90 kPa), at or below about −27 in Hg (about −91 kPa), at or below about −27.5 in Hg (−93 kPa), at or below about −28 in Hg (about −95 kPa), at or below about −28.5 in Hg (about −96.5 kPa), at or below about −29 in Hg (about −98 kPa), at or below about −29.5 in Hg (about −100 kPa), at or below about −30 in Hg (about −101.5 kPa), such as at or below about −35 in Hg (about −119 kPa), which can be sufficient to reduce void space within a polycarbonate part formed by SLS.

The threshold pressure within the mold cavity 126 can be selected to provide for a predetermined porosity percentage of the resulting part 12 after SLS in the vacuum environment. The threshold vacuum pressure can be selected so that a predetermined absolute porosity within the resulting part is achieved, such as a porosity of about 15% or less, for example about 10% or less, such as about 7% or less, about 6.5% or less, about 6% or less, about 5.5% or less, about 5% or less, about 4% or less, about 3% or less, or about 2.5% or less. The threshold vacuum pressure can be selected to provide for a percentage reduction of the porosity in the final part compared to the porosity of the unsoftened and unfused powder (e.g., the polycarbonate powder 130 before being melted in the mold 124) or compared to the porosity that would have occurred if the vacuum pressure had not been applied before, during, or immediately after rotomolding. The threshold vacuum pressure can be selected so that the final density of the final part is at or above a predetermined density, which can depend on the material or materials being used to form the part. The threshold vacuum pressure can be selected so that the density of the final part is increased by a predetermined percentage compared to the density of the unsoftened and unfused powder or compared to the density that would have occurred if the vacuum pressure had not been applied before, during, or immediately after rotomolding.

The threshold pressure within the mold cavity 126 can be selected to achieve a porosity below a threshold porosity selected based on a resulting threshold value for a specified physical property, such as the flexural strength of the part. It has been found by the inventors that for amorphous polymeric materials, such as polycarbonate, when the porosity of the part is above a certain threshold, then the flexural strength can be reduced in a proportional manner as the porosity increases. However, the flexural strength can tend to be about equal when the porosity of the part is below the threshold value. FIG. 2 (described above) shows the relationship between the porosity of a polycarbonate part and the flexural strength of the polycarbonate part. As can be seen in FIG. 2, there is a distinct porosity threshold at about 6%, which can be ±about 0.5% in some examples. Below this threshold 6% porosity, the flexural strength of the part can tend to cluster around an average of about 76 megapascals (MPa). But, above the threshold 6% porosity, the flexural strength can decrease in approximately a linear fashion corresponding to the porosity percentage. It is expected that other amorphous polymeric materials will also exhibit a porosity threshold value similar to that shown for polycarbonate.

The rotomold system 120 can also include a pressure sensor, such as a pressure gauge, that measures the pressure of the mold cavity 126. The pressure sensor can be used to control the vacuum device 148 in order to achieve a predetermined vacuum pressure within the mold cavity 126, such as via a pressure control system. The pressure sensor can be in communication with a controller or processor that can be programed or otherwise configured to operate with a feedback loop between the pressure sensor and the vacuum device 148. The pressure sensor can also be used to control the heater 132 so that the heater 132 is only activated when the mold cavity 126 is under a predetermined pressure or pressure range. For example, it may be desired that the heater 132 heat the mold 124 and the powder 130 therein only when the predetermined vacuum pressure is being applied to the mold cavity 126, e.g., only when the pressure in the mold cavity 126 is at or below a threshold pressure. Alternatively, the rotomold system 120 can be configured so that the heater 132 heats the mold 124 when the pressure in the mold cavity 126 is above the pressure threshold.

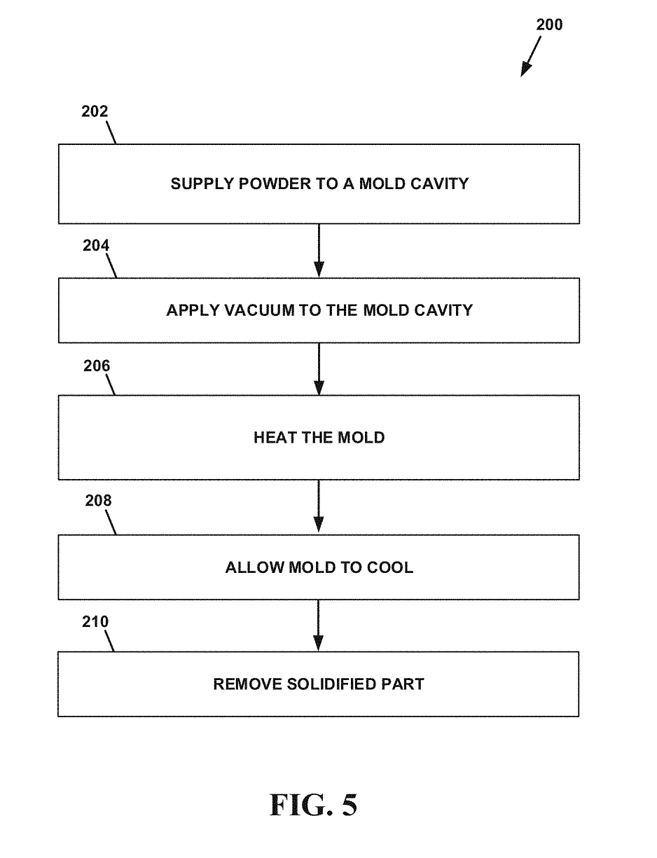

FIG. 5 is a flow diagram of an example method 200 of forming a part via rotomolding of a fusible powder comprising an amorphous polymeric material, such as a polycarbonate powder. The method 200 can include, at 202, supplying a polycarbonate powder to a cavity of a mold that is part of a rotomold system. At 204, a vacuum can be applied to the mold cavity until the pressure within the mold cavity is at or below a predetermined pressure threshold. As described above, the predetermined pressure threshold can be selected to achieve one or more of: a porosity at or below a predetermined porosity of the resulting part; at least a predetermined reduction in porosity compared to the porosity of the unsoftened and unfused powder or compared to the porosity that would have resulted if the vacuum was not applied; a density at or above a predetermined density; at least a predetermined increase in density compared to the density of the unsoftened and unfused powder or compared to the density that would have resulted if the vacuum was not applied. The application of the vacuum (204) can cause air within the mold cavity to be evacuated, including at least a portion of the air within void spaces of the powder. The application of the vacuum (204) can also evacuate compounds other than air from the powder, such as volatile compounds including volatile organic compounds that may be present in the amorphous powder, for example, volatile byproducts left over after manufacturing the polymeric material or formation of the powder.

At 206, the mold can be heated to melt and fuse at least a portion of the powder to form a fused polycarbonate part. The heating (206) can be performed while applying the vacuum (204) so that the evacuation of air and other compounds, described above, can occur when the polymeric powder is in a molten or semi-molten state. The application of the vacuum (204) and the heating (206) can result in the fused polycarbonate part being at or below a specified threshold porosity, wherein the vacuum pressure applied (step 204) can be selected to achieve a porosity at or below the specified threshold porosity.

After applying the vacuum (204) and heating the mold (206) for a time sufficient to melt the polymer material of the powder, e.g., the polycarbonate, at 208, the mold can be allowed to cool so that the molten polymer material that had formed the powder is allowed to resolidify in the shape of the part being formed. At 210, the solidified part can be removed from the mold, and the process can be repeated, e.g., by refilling the mold cavity with polycarbonate powder (202), applying the specified vacuum pressure to the mold cavity (204), heating the mold (206), allowing the part to cool and solidify (208), and removing the solidified part from the mold (210).

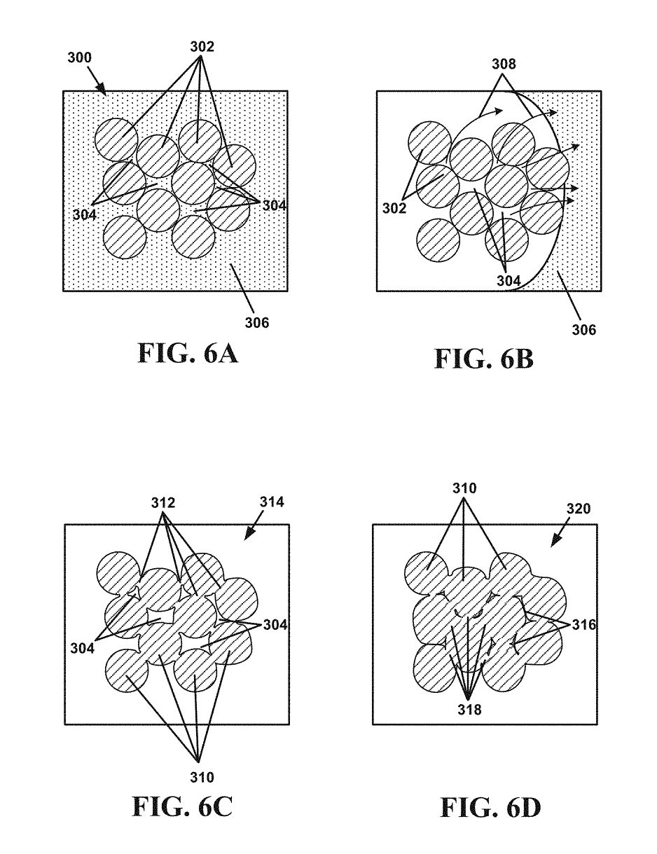

FIGS. 6A-6D show a conceptual view of what is believed to occur during the process of selective laser sintering or rotomolding of an amorphous polymeric powder, such as a polycarbonate powder, in a vacuum environment that is capable of reducing or eliminating the void spaces in the part that would typically have formed without application of the vacuum environment. FIG. 6A shows a conceptual close-up view of an amorphous polymeric powder 300, e.g., a polycarbonate powder, comprising a plurality of particles 302 before selective laser sintering or rotomolding of the powder 300. The particles 302 shown in FIG. 6A can represent the state of the powder 22 in the powder bed 28 before application of the laser beam 42, as described with respect to FIG. 1, or of the powder 130 in the mold cavity 126 before being heated in the rotomold system 120 of FIG. 4. The particles 302 can become closely packed together, resulting in a plurality of void spaces 304 between and around the particles 302. At the stage of the process shown in FIG. 6A, there is still air 306 present around the powder 300 and within the void spaces 304.

FIG. 6B is a conceptual close-up view of the amorphous polymeric powder 300 upon initiation of application of a vacuum, which results in evacuation of at least a portion of the air 306 from the build chamber. The evacuation of the air 306 can also cause at least a portion of the air 306 to be evacuated from the void spaces 304, represented conceptually by arrows 308 in FIG. 6B. After the vacuum has been applied to the build chamber for a sufficient period of time, the air 306 is evacuated from the build chamber. The term “evacuated,” as used herein when referring to the build chamber and/or the void spaces 304, can refer to a partial pressure of air within the build chamber and the void spaces 304 being below the threshold pressure.

After the air 306 has been evacuated from the build chamber and the void spaces 304, a heating device (such as the laser system 10 in the SLS system 10 of FIG. 1 or the heater 132 in the rotomold system 120 of FIG. 4) can be used to at least partially melt the polymeric material of the powder particles 302, e.g., polycarbonate, so that the particles 302 can become at least partially fused to form a part. FIG. 6C is a conceptual close-up view of the amorphous polymeric powder after the particles 302 have been heated, such as with a focused energy beam, e.g., a laser beam, as with SLS, or with a heater as part of a rotomolding process, in order to increase a localized temperature of the powder 300 above a softening or melting temperature of the amorphous material so that the particles 302 of FIGS. 3A and 3B become softened or melted to form softened or melted amorphous particles 310. The particles 310 can become softened or melted such that the particles 308 become fused together at a plurality of fusion interfaces 312 resulting in a fused powder 314.

FIG. 6C is being shown at a time substantially immediately after the amorphous material has been softened or melted so that the particles 310 become fused together at the fusion interfaces 312, but before the void spaces 304 have collapsed due to the evacuation of the air 306 from the void spaces 304. FIG. 6D is a conceptual close-up view of the softened/melted and fused amorphous polymeric powder 314 at a time after that which is shown in FIG. 6C. As described above, air 306 has been evacuated from the void spaces 304, and the weight and/or interior pressure within the softened or melted particles 310 can result in at least partially collapsed void spaces 316 around the softened or melted particles 310 (FIG. 6D). The collapsed void spaces 316 can also result in contact of a larger surface area of the softened or melted particles 310, which can produce larger fusion interfaces 318. The collapsed void spaces 316 and larger fusion interfaces 318 can provide for a condensed fused powder 320 that has a higher density and a lower percentage of void space than the fused powder 314 shown in FIG. 6C, e.g., with a higher density and lower void space fraction than would have been possible without application of the vacuum resulting in evacuation of the air 306 from the void spaces 304.

It is also hypothesized by the inventors that the application of the vacuum encourages rapid dissolution of absorbed moisture or other volatiles during the heating and sintering process of either SLS or rotomolding. Implementation of a vacuum in rotomolding can be challenging because the rotomolding system 120 will need to withstand relatively high negative pressures, e.g., as high as about 1 atmosphere of negative pressure. In can also be difficult to avoid clogging of the vacuum outlet 146 during the molding operation. However, it is believed that the use of a vacuum during rotomolding can allow for the formation of relatively thick cross-sections of the part, with relatively low porosities that are substantially “bubble-free.” To date, the inventors have formed polycarbonate sheets that are up to 0.5 inches (about 1.3 cm) thick, and it is believed that even thicker cross-sections of clear polycarbonate may be possible using the rotomolding techniques described herein.

### EXAMPLE

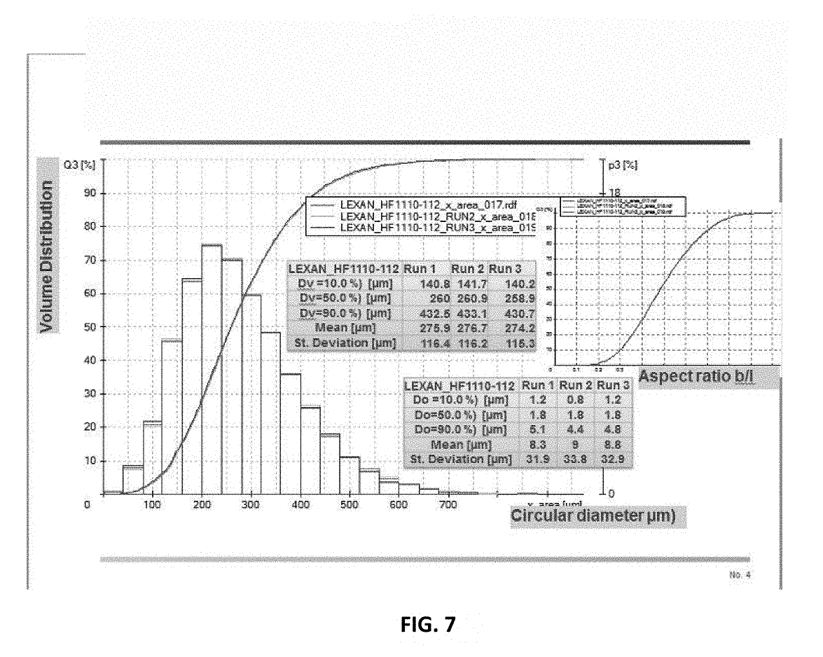

Polycarbonate resin (sold under the trade name LEXAN HF1110-112 by the SABIC Innovative Plastics (SABIC), Pittsfield, Mass., USA) was ground using equipment that is designed to produce commercial powders for the rotomolding industry. The intent was to produce a particle distribution similar to a benchmark medium density polyethylene (MDPE). The particle size distribution of the polycarbonate powder is illustrated in FIG. 7, wherein μm is micrometers. FIG. 7 is a graphical representation of the size and shape repeatability.

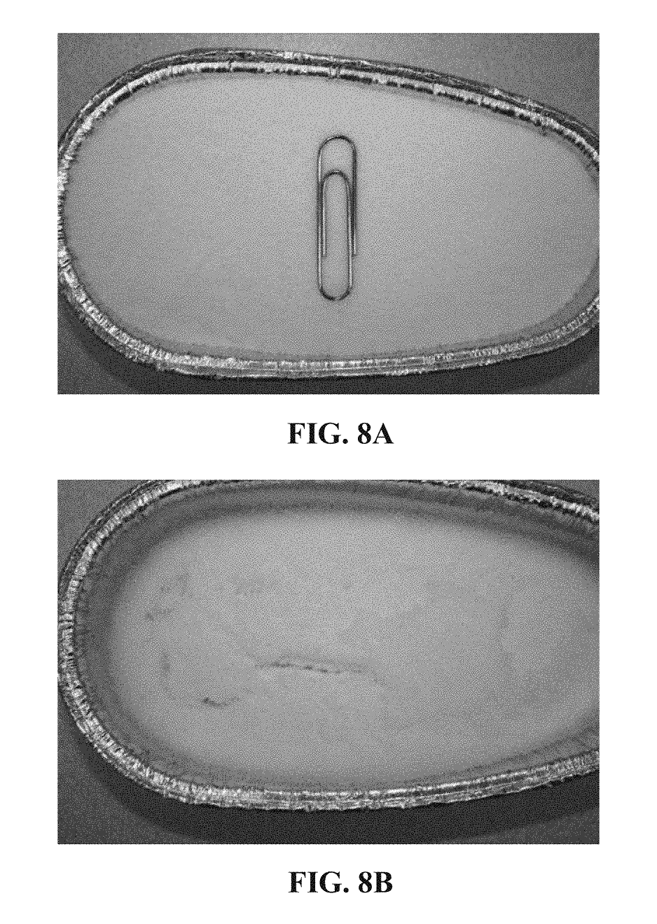

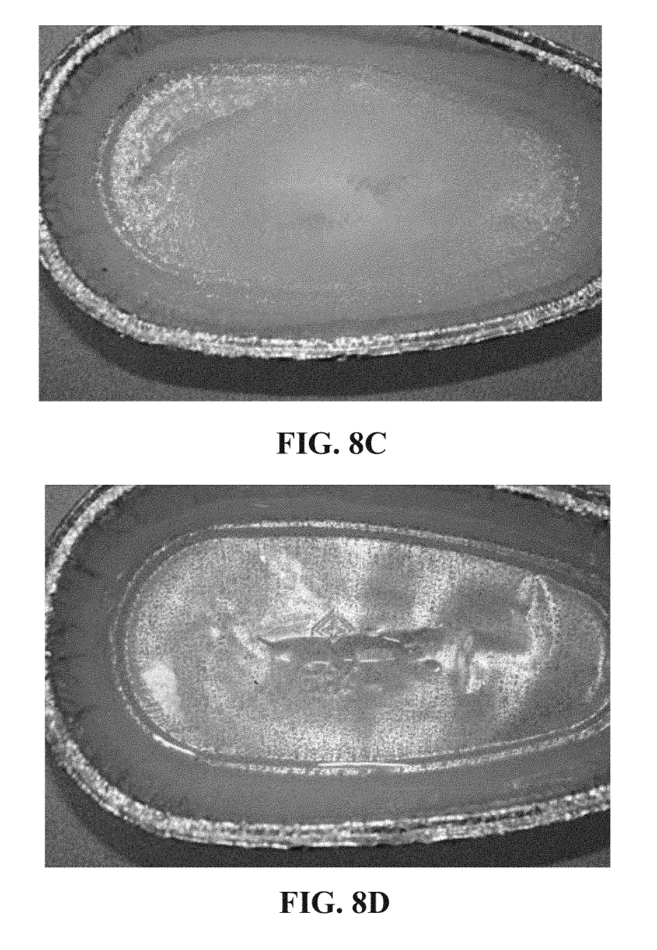

The polycarbonate powder was used in a series of heating studies designed to help understand the sintering and consolidation process for polycarbonate resin. Powder samples were loaded in small aluminum trays and placed in a forced convection oven at 500° F. (about 260° C.). The samples were removed at various intervals to determine the time necessary to produce a freely formed polycarbonate slab. It was determined that approximately 20-30 minutes was required when the polycarbonate powder was pre-loaded into trays at an initial thickness of 0.75 inches (about 1.9 cm). This study provided understanding of the consolidation process for ground polycarbonate powder. It also showed that air and volatile entrapment is an issue, even when the powder is dried to levels that are required in injection molding and extrusion, e.g., a moisture content of less than 0.04 wt.%, before placing the powder in the oven. FIGS. 8A-8B show a sequence of the polycarbonate powder at various times during polycarbonate powder consolidation without the application of vacuum during the heating cycle. FIG. 8A shows an aluminum tray loaded with the polycarbonate powder before being placed in the oven. FIG. 8B shows the polycarbonate powder after 14 minutes in the oven at 500° F. (about 260° C.). FIG. 8C shows the polycarbonate powder after 17 minutes in the oven at 500° F. (about 260° C.). FIG. 8D shows the tray after complete melting of the polycarbonate powder, which occurred at about 22 minutes in the oven at 500° F. (about 260° C.). As can be seen in FIG. 8D, there are bubbles and other voids present in the molten polycarbonate.

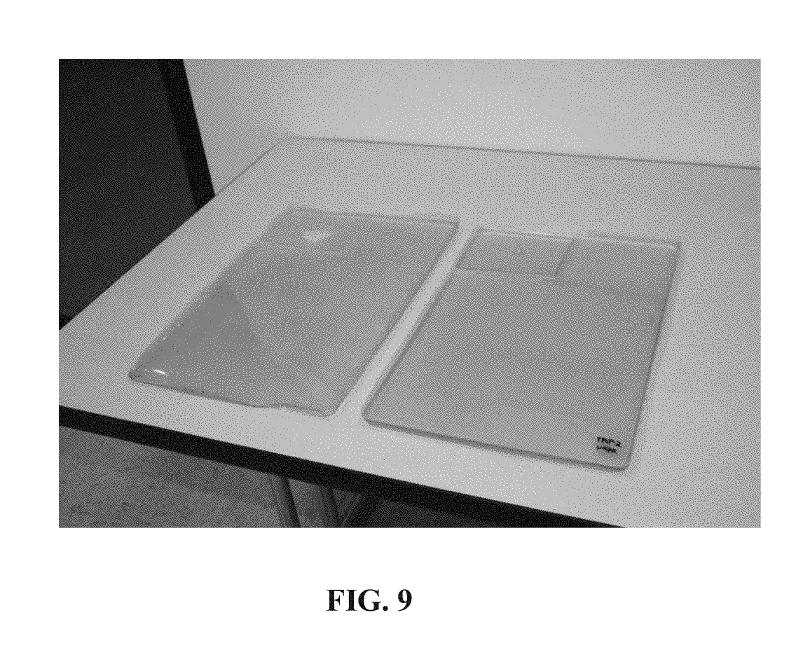

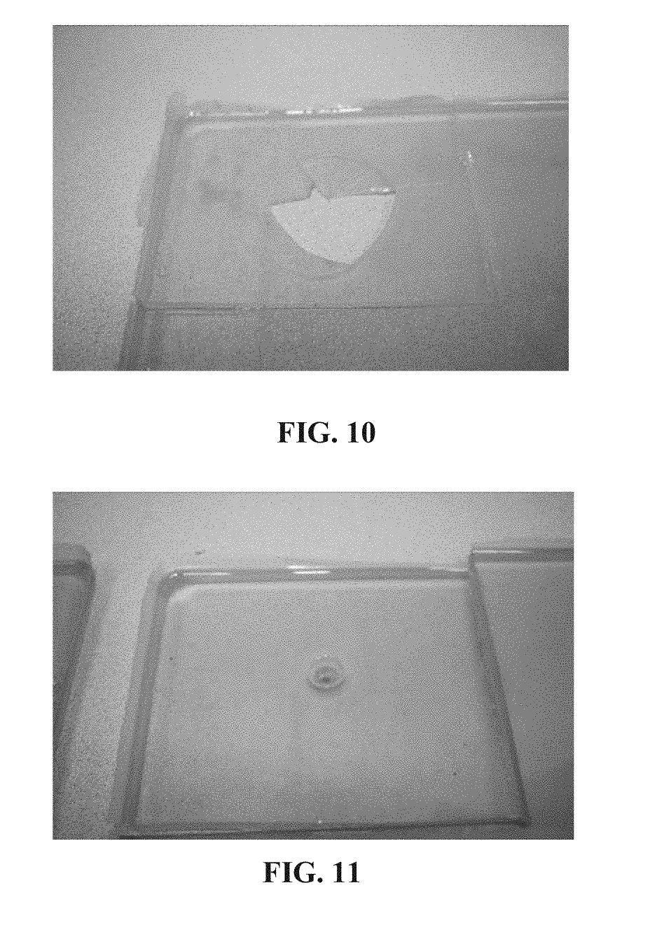

In a second experiment, a larger coated tray was loaded with dried polycarbonate powder (LEXAN HF1110-112, sold by SABIC, Pittsfield, Mass., USA) and placed in a convection oven at 500° F. (about 260° C.). The large coated tray was held for 30 minutes, cooled and an impact sample was extracted and tested. The same experiment was repeated in a vacuum press. Stops were used to prevent platen contact and vacuum was created and held at a nominal value of about −28.5 inches Hg. FIG. 9 shows the non-vacuum treated plate on the left and the vacuum-treated plate on the right. FIGS. 10 and 11 show close-up views of the impacted samples taken from the same sintered slabs.

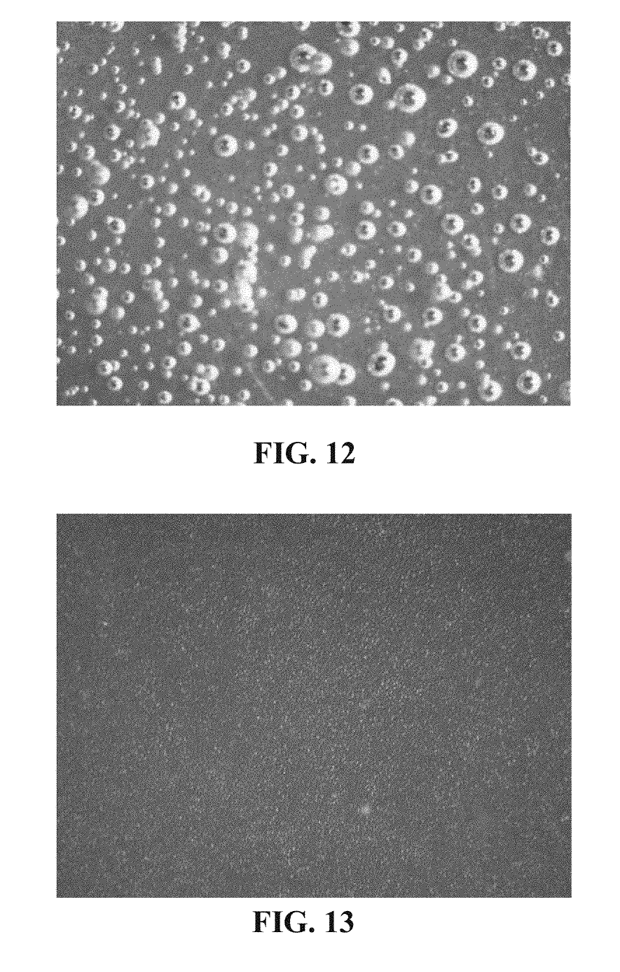

Magnification of the samples reveals that polycarbonate powder that is consolidated in a convection oven without vacuum assistance is riddled with spherical voids. FIG. 12 shows a low-power (10×) micrograph of the non-vacuum-assisted sample (FIG. 10). The voids are small, but likely contribute to a reduction in impact performance. FIG. 13 shows a low-power (10×) micrograph view of a vacuum-assisted consolidation sample (FIG. 11). The sample in FIG. 13 looks and behaves similar to injection molded or extruded polycarbonate.

The sample from the vacuum-assisted consolidation (FIGS. 11 and 13) is consistent with properly molded or extruded polycarbonate. The difference is visually noticeable and appears to translate to mechanical properties.

Set forth below are some embodiments of the systems and methods disclosed herein.

### Embodiment 1

A system for fabricating a part comprising: a build chamber; a powder feed system for feeding a polymeric powder to the build chamber; a heating system for melting and fusing the polymeric powder to form a fused polymeric part in the build chamber; and a vacuum system to apply a specified vacuum pressure to the build chamber, wherein the vacuum pressure is at or below a threshold pressure so that a porosity of the fused polymeric part is at or below a specified threshold porosity.

### Embodiment 2

The system according to Embodiment 1, wherein the polymeric powder is an amorphous polymeric powder; preferably wherein the polymeric powder comprises polycarbonate powder.

### Embodiment 3

The system according to any one of the preceding Embodiments, wherein the build chamber comprises a mold and the heating system comprises an oven for heating the mold to melt the polymeric powder in the mold.

### Embodiment 4

The system according to Embodiment 3, further comprising a rotational mechanism to rotate the mold during heating.

### Embodiment 5

The system according to any one of the preceding Embodiments, wherein the heating system comprises a laser system comprising: a laser to emit a focused energy beam onto a target area within the build chamber, and a laser-positioning system to aim the focused energy beam onto selected positions of the target area in order to fuse a portion of the polymeric powder at the target area to form a fused polymeric part.

### Embodiment 6

The system according to any one of the preceding Embodiments, further comprising a control system to control the vacuum system based on a pressure measured in the build chamber.

### Embodiment 7

The system according to any one of the preceding Embodiments, wherein the specified threshold porosity is 15% by volume or less; preferably wherein the specified threshold porosity is 6% by volume or less; preferably wherein the specified threshold porosity is about 6% by volume.

### Embodiment 8

The system according to any one of the preceding Embodiments, wherein the threshold pressure is at or below about −20 inches of mercury; preferably wherein the threshold pressure is at or below about −25 inches of mercury; preferably wherein the threshold pressure is at or below about −30 inches of mercury.

### Embodiment 9

The system according to any one of the preceding Embodiments, further comprising a purge gas feed system to feed a purge gas to the build chamber.

### Embodiment 10

A method for fabricating a part, the method comprising: feeding a polymeric powder to a build chamber; applying a specified vacuum pressure to the build chamber; and while applying the vacuum, heating at least a portion of the polymeric powder within the build chamber to melt and fuse at least a portion of the polymeric powder to form a fused polymeric part; and wherein the specified vacuum pressure is selected so that a porosity of the fused polymeric part is at or below a specified threshold porosity.

### Embodiment 11

The method according to Embodiment 10, wherein the polymeric powder is an amorphous polymeric powder; preferably wherein the polymeric powder comprises polycarbonate powder.

### Embodiment 12

The method according to any of Embodiments 10-11, wherein the build chamber comprises a mold and heating at least the portion of the polymeric powder comprises heating the mold to melt and fuse the polymeric powder in the mold.

### Embodiment 13

The method according to any of Embodiments 10-12, further comprising rotating the mold while heating the mold to melt and fuse the polymeric powder.

### Embodiment 14

The method according to any of Embodiments 10-13, wherein heating at least the portion of the polymeric powder comprises selectively directing a focused energy beam to selected positions of the build chamber to fuse a portion of the polymeric powder to form the fused polymeric part.

### Embodiment 15

The method according to any of Embodiments 10-14, further comprising controlling the application of the vacuum pressure based on a measured pressure in the build chamber.

### Embodiment 16

The method according to any of Embodiments 10-15, wherein the specified threshold porosity is 15% by volume or less; preferably wherein the specified threshold porosity is 6% by volume or less; preferably wherein the specified threshold porosity is about 6% by volume.

### Embodiment 17

The method according to any of Embodiments 10-16, wherein the threshold pressure is at or below about −20 inches of mercury; preferably wherein the threshold pressure is at or below about −25 inches of mercury; preferably wherein the threshold pressure is at or below about −30 inches of mercury.

### Embodiment 18

The method according to any of Embodiments 10-17, further comprising feeding a purge gas to the build chamber.

The above Detailed Description is intended to be illustrative, and not restrictive. For example, the above-described examples (or one or more elements thereof) can be used in combination with each other. Other embodiments can be used, such as by one of ordinary skill in the art upon reviewing the above description. Also, various features or elements can be grouped together to streamline the disclosure. This should not be interpreted as intending that an unclaimed disclosed feature is essential to any claim. Rather, inventive subject matter can lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” The term “about” is intended to include the degree of error associated with measurement of the particular quantity based upon the equipment available as of Feb. 23, 2015. Also, in the following claims, the terms “including” and “comprising” are open-ended, that is, a molding system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects. This application claims priority to U.S. Provisional Application No. 62/119,328, filed on Feb. 23, 2015, the entire disclosure of which is incorporated herein by reference.

Method examples described herein can be machine or computer-implemented, at least in part. Some examples can include a computer-readable medium or machine-readable medium encoded with instructions operable to configure an electronic device to perform methods or method steps as described in the above examples. An implementation of such methods or method steps can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The Abstract is provided to comply with 37 C.F.R. §1.72(b), to allow the reader to quickly ascertain the nature of the technical disclosure. It is submitted with the understanding that it will not be used to interpret or limit the scope or meaning of the claims.

Although the invention has been described with reference to exemplary embodiments, workers skilled in the art will recognize that changes may be made in form and detail without departing from the spirit and scope of the invention.

1. A system for fabricating a part comprising:
a build chamber comprising a mold, the mold comprising a mold cavity, the mold cavity including a vacuum outlet;
a powder feed system for feeding a polymeric powder to the build chamber wherein the polymeric powder is an amorphous polymeric powder;
a heating system for melting and fusing the polymeric powder to form a fused polymeric part in the build chamber;
a rotational mechanism to rotate the mold during heating; and
a vacuum system capable of applying a pressure at or below −20 inches mercury, the vacuum outlet being in fluid communication with the mold cavity and with a vacuum system, the vacuum system to apply a specified vacuum pressure of at or below about −20 inches mercury to the build chamber by drawing the specified vacuum pressure through the vacuum outlet, wherein the vacuum pressure is at or below a threshold pressure so that a porosity of the fused polymeric part is at or below a specified threshold porosity, wherein the specified threshold porosity is 15% by volume or less.

2. The system according to claim 1, wherein the polymeric powder comprises polycarbonate powder.

3. The system according to claim 1, wherein the heating system comprises an oven for heating the mold to melt the polymeric powder in the mold.

4. (canceled)

5. The system according to claim 1, wherein the heating system comprises a laser system comprising:
a laser to emit a focused energy beam onto a target area within the build chamber, and
a laser-positioning system to aim the focused energy beam onto selected positions of the target area in order to fuse a portion of the polymeric powder at the target area to form a fused polymeric part.

6. The system according to claim 1, further comprising a control system to control the vacuum system based on a pressure measured in the build chamber.

7. The system according to claim 1, wherein the specified threshold porosity is 6% by volume or less.

8. The system according to claim 1, wherein the threshold pressure is at or below about −25 inches of mercury.

9. The system according to claim 1, further comprising a purge gas feed system to feed a purge gas to the build chamber.

10. A method for fabricating a part, the method comprising:
feeding a polymeric powder to a build chamber, wherein the polymeric powder is an amorphous polymeric powder;
applying a specified vacuum pressure to the build chamber; and
while applying the vacuum, heating at least a portion of the polymeric powder within the build chamber and rotating the mold while heating the mold to melt and fuse at least a portion of the polymeric powder to form a fused polymeric part;
wherein the specified vacuum pressure is selected so that a porosity of the fused polymeric part is at or below a specified threshold porosity, wherein the specified threshold porosity is 15% by volume or less.

11. The method according to claim 10, wherein the polymeric powder comprises polycarbonate powder.

12. (canceled)

13. (canceled)

14. The method according to claim 10, wherein heating at least the portion of the polymeric powder comprises selectively directing a focused energy beam to selected positions of the build chamber to fuse a portion of the polymeric powder to form the fused polymeric part.

15. The method according to claim 10, further comprising controlling the application of the vacuum pressure based on a measured pressure in the build chamber.

16. The method according to claim 10, wherein the specified threshold porosity is 6% by volume or less; preferably wherein the specified threshold porosity is about 6% by volume.

17. The method according to claim 10, wherein the threshold pressure is at or below about −25 inches of mercury.

18. The method according to claim 10, further comprising feeding a purge gas to the build chamber.
